(19) United States
(12) Patent Application Publication
(10) Pub. No.: US 2023/0083373 A1
(43) Pub. Date: Mar. 16, 2023

(54) Device For Predicting Blade Breakage Of A Bandsaw Blade Of A Bandsaw

(71) Applicant: Gebrueder Linck Maschinenfabrik "Gatterkinck" GmbH & Co. KG, Oberkirch (DE)

(72) Inventors: Robert MAIER, Toeging (DE); Martin BOCK, Buch Am Buchrain (DE)

(21) Appl. No.: 17/895,365

(22) Filed: Aug. 25, 2022

Related U.S. Application Data
(63) Continuation of application No. PCT/EP2021/053531, filed on Feb. 12, 2021.

(30) Foreign Application Priority Data
Feb. 27, 2020 (DE) 10 2020 105 223.5

(51) Int. Cl. B23D 59/00; B23D 55/08; B23Q 17/09

(52) U.S. Cl. CPC B23D 59/001; B23D 55/082; B23Q 17/0995; B23Q 17/0957; B23Q 2717/00

(57) ABSTRACT

A device for predicting a blade breakage of a bandsaw blade of a bandsaw. The device comprises an eddy-current sensor configured to generate a sensor signal that is dependent on a technical parameter of the bandsaw blade. The device further comprises an evaluation unit configured to evaluate the sensor signal, to compare the sensor signal with a predetermined tolerance range, and to generate a warning signal that indicates an imminent blade breakage of the bandsaw blade if the sensor signal lies outside of the predetermined tolerance range.

### CROSS-REFERENCE TO RELATED APPLICATIONS

This application is a continuation of International Application No. PCT/EP2021/053531, filed on Feb. 12, 2021, which claims the benefit of German Application No. 10 2020 105 223.5, filed on Feb. 27, 2020. The entire disclosures of the above applications are incorporated herein by reference.

### FIELD

This disclosure relates to a device for predicting a blade breakage of a bandsaw blade of a bandsaw. This disclosure furthermore relates to a bandsaw comprising such a device.

### BACKGROUND

This section provides background information related to the present disclosure which is not necessarily prior art.

Bandsaws typically have two mutually spaced bandsaw wheels that rotate about mostly parallel axes of rotation. In other applications, one of the axes of rotation is tiltable relative to the other in order to adjust the position of the bandsaw blade with respect to a front edge of the bandsaw wheel(s). The saw blade of a bandsaw, typically referred to as a bandsaw blade or endless saw blade, is guided by and rotates around the two bandsaw wheels. At least one of the two bandsaw wheels is motor-driven, and in this way moves the bandsaw blade at an adjustable speed.

In order to ensure a guided motion of the bandsaw blade on a predetermined path even when a material to be sawed, for example wood, is guided with a certain force, in a feed direction typically parallel to at least one of the two axes of rotation, against a narrow side of the bandsaw blade that is provided, for example, with saw teeth, the bandsaw blade is tensioned with high mechanical force. This tensioning is effected, for example, by increasing the center distance between the bandsaw wheels. This sawing principle can be used for any type of bandsaw blade, e.g. also for toothless bandsaw blades with diamond edging or similar for cutting stones.

Due to the revolving of the bandsaw blade over the bandsaw wheels and the high effective tensile stress, as well as the cutting forces occurring during the machining process, the bandsaw blade is subject to constant mechanical and thermal stress, which can result in the formation of micro-cracks, and ultimately macro-cracks. A corresponding propagation of and/or increase in the number of cracks can result in breakage of the bandsaw blade, which can damage or even destroy the bandsaw and adjacent machine parts.

A blade breakage results in stoppage of the bandsaw and thus in a loss of production, which has economically detrimental consequences, and in particular can be dangerous for an operator.

It is therefore advantageous to be able to predict such blade breakages at an early stage before a total failure due to a blade breakage occurs. The possibility of prediction also reduces the risk that a bandsaw blade that is actually still undamaged is replaced at an early stage and preventatively replaced with a new bandsaw blade.

DE 10 2018 118 369 A1, for example, discloses a device for visually sensing an alternating motion of the bandsaw blade, which allows inferences to be drawn about an impending blade breakage. This requires a very high accuracy of the visually operating sensor, which entails high investment costs.

Furthermore, CN 107 449 600 A discloses a method for blade breakage detection, in which, inter alia, transverse, vibration-related displacement parameters are sensed by means of a speed and force sensor, and lateral, vibration-related displacement parameters are sensed by means of an eddy-current sensor. Existing tooth line cracks in a bandsaw blade can be detected, or diagnosed, through comprehensive data analysis of the transverse and lateral displacement parameters. However, this type of evaluation is ultimately also very costly and complex.

### SUMMARY

This section provides a general summary of the disclosure, and is not a comprehensive disclosure of its full scope or all of its features.

It is an object to provide a comparatively simple and inexpensive device by which a blade breakage of a bandsaw blade of a bandsaw can be predicted before a complete breakage of the bandsaw blade occurs.

According to a first aspect, a device for predicting a blade breakage of a bandsaw blade of a bandsaw is presented. The device comprises an eddy-current sensor, which is configured to generate a sensor signal that is dependent on and indicates a technical parameter of the bandsaw blade. Further, the device has an evaluation unit, which is configured to evaluate the sensor signal, to compare the sensor signal with a predetermined tolerance range, and to generate a warning signal that indicates an imminent blade breakage of the bandsaw blade if the sensor signal lies outside of the predetermined tolerance range.

According to a second aspect, a bandsaw is presented that comprises a first bandsaw wheel rotatably mounted about a first rotation axis; a second bandsaw wheel rotatably mounted about a second rotation axis, the second rotation axis being arranged parallel to and spaced apart from the first rotation axis; a bandsaw blade that is guided over the first bandsaw wheel and the second band-saw wheel so as to execute a revolving motion around the first bandsaw wheel and the second bandsaw wheel; and a device for predicting a blade breakage of the bandsaw blade. The device comprises an eddy-current sensor configured to generate a sensor signal that is dependent on and indicates a technical parameter of the bandsaw blade, and an evaluation unit configured to evaluate the sensor signal, to compare the sensor signal with a predetermined tolerance range, and to generate a warning signal that indicates an imminent blade breakage of the bandsaw blade if the sensor signal lies outside of the predetermined tolerance range.

A main advantage of the presented device, and of a bandsaw comprising the device, is that an impending blade breakage can be detected at an early stage, such that the bandsaw blade can be replaced in good time before a blade breakage occurs. Thus, adverse consequences and dangers associated with such a blade breakage can be avoided by use of the device.

The use of an eddy-current sensor also improves the possibility of predicting an impending blade breakage of a bandsaw blade of a bandsaw, on the one hand, because blade breakages can be detected more accurately compared to optical measuring methods. On the other hand, the investment costs can be reduced due to the relatively inexpensive eddy-current sensor compared to optical prediction devices.

The evaluation unit may be configured to analyze signal changes in the sensor signal and to generate the warning signal if the sensor signal exceeds or falls below a predefined absolute value and/or the signal change of the sensor signal exceeds a predefined threshold value. The analysis of the sensor signal may thus be effected both by consideration of the absolute values of the sensor signal and by consideration of the differential values (time derivative) of the sensor signal.

The sensor signal can be used, for example, to detect material non-uniformities. Since, apart from minor deviations, it can be assumed that the surface of the saw blade is largely homogeneous, these material non-uniformities, or material irregularities, indicate defects and/or minor cracks in the saw blade, which could possibly result in a complete crack of the saw blade during further operation of the saw.

In contrast to CN 107 449 600 A, it is possible to predict an impending blade breakage solely by evaluation of the sensor signal generated by an eddy-current sensor, whereas in CN 107 449 600 A such a prediction is not possible, since only existing blade breakages can be diagnosed.

With the herein presented device, a blade breakage may already be sensed in a micro-crack stage in which the incipient blade breakage cannot yet be discerned, i.e. before the occurrence of vibrations and/or before a crack-related oscillation of the saw blade.

The herein presented device also has the advantage that a simpler data analysis becomes possible, since only the sensor signal that depends on the technical parameter indicating a blade breakage is evaluated.

The sensor signal generated by the eddy-current sensor is dependent on and indicates a (predetermined) technical parameter of the bandsaw blade. In other words, at least a part of the sensor signal thus indicates such a technical parameter of the bandsaw blade. The dependence of the sensor signal on the technical parameter may be proportional. However, other mathematically representable dependencies of the sensor signal on the technical parameter are also possible.

The predetermined tolerance range defines a range around a tolerance value ±of a predetermined, non-tolerable deviation (e.g. ±10 percent (%)) from this tolerance value. The tolerance value is preferably specified in advance, depending on the technical parameter considered, for example based on measurement and/or test results.

In a refinement, the evaluation unit is configured to determine the technical parameter based on the sensor signal.

The evaluation unit thus preferably evaluates the sensor signal in such a manner that at least one technical parameter of the bandsaw blade can be extracted from the sensor signal without signal-interfering components and compared with the predetermined tolerance range.

Depending on the technical parameter considered, the warning signal can be generated either if the determined technical parameter exceeds or falls below the predetermined tolerance range.

In a further refinement, the evaluation unit is configured to electronically filter and/or smooth the sensor signal and to effect the comparison with the predetermined tolerance range based on the filtered and/or smoothed sensor signal.

The signal evaluation preferably has a signal pre-filtering. In other words, the signal evaluation has a single- or multi-stage signal filtering and/or a single- or multi-stage signal smoothing (e.g. by means of high-pass and low-pass filtering), by means of which, for example, disturbance variables can be filtered out of the sensor signal or signal excursions can be smoothed, such that an as optimal as possible, disturbance-free evaluation of the technical parameter is possible. This has the advantage that an exact prediction of an impending blade breakage becomes possible, since signal changes, which are caused for example by weld points on the bandsaw blade, are automatically filtered out and thus do not result in the warning signal being generated unintentionally. This also allows signal changes caused by minor scratches, dents or compressions to be filtered out.

In a refinement, the technical parameter comprises a dimensional property of the bandsaw blade.

This refinement has the advantage that, by means of the eddy-current sensor, or by means of the sensor signal recorded by the eddy-current sensor in the evaluation unit, preferably also a length and/or thickness of the bandsaw blade can be determined (as an addition, as it were, that can be determined from the sensor signal), as long as the bandsaw blade is made of an electrically conductive material. Preferably, the evaluation unit can also determine thicknesses and/or lengths of between 0.5 mm and 140 mm based on the sensor signal of the eddy-current sensor. In particular, it is advantageous if, in addition to the blade breakage detection, the blade thickness of the bandsaw blade and/or its time-related and/or spatial variation is also determined as a further technical parameter. In an evaluation of the sensor signal in which the blade thickness is also determined, the motion of the bandsaw blade provides information about the blade thickness, which information varies over time and indicates position-dependent irregularities in the blade thickness.

In further refinements, it is also possible to detect an impending blade breakage from the change in blade thickness, in which case this may be effected alternatively or in addition to the evaluation of irregularities in the sensor signal, but is not necessary. If, for example, an unusually large signal change occurs in the sensor signal, this is a strong indication that there is a significant irregularity in the blade thickness at the respective point on the bandsaw blade, which in turn can be an indication of an imminent blade breakage.

In a further refinement, the evaluation unit is configured to determine from the sensor signal, as the technical parameter, a saw blade thickness of the bandsaw blade, and to generate the warning signal if the saw blade thickness is outside of a predetermined tolerance range.

In this refinement, it is advantageous if the predetermined tolerance value is a limit saw blade thickness ±of a still tolerable deviation (for example, of ±10% from the tolerance value). If the saw blade thickness departs from the predetermined tolerance range, an acoustic, visual and/or tactile warning signal is preferably generated and output. Based on the warning signal, the bandsaw may be stopped manually (by the operator) or automatically (by the evaluation unit or a controller).

It is preferred if the predefined tolerance value, or tolerance range, is updated during operation of the bandsaw based on a measurement data history and, for example, is set to a new, more precise tolerance value, or tolerance range, in order to ensure continuous optimization of the prediction of a blade breakage of the bandsaw blade.

In a further refinement, the eddy-current sensor is configured to generate the sensor signal while the bandsaw blade is executing a revolving motion.

In other words, the blade breakage prediction is effected during operation of the bandsaw, i.e. on a bandsaw blade that is moving past the eddy-current sensor at, for example, 50 meters per second. This is advantageous, in particular, because it is not necessary to stop or interrupt the sawing operation in order to predict impending blade breakages; instead, the prediction of whether or not a blade breakage is impending can be made, as it were, during continuous operation of the bandsaw. Moreover, since the bandsaw blade moves past the eddy current sensor, use can be made of the physical fact that an electrically conductive material moving in a magnetic field induces a voltage, or an eddy current.

In a further refinement, the eddy-current sensor is configured to generate a magnetic field oriented substantially perpendicularly to a blade surface of the bandsaw blade, wherein the magnetic field induces in the bandsaw blade a voltage that causes eddy currents.

For this purpose, the eddy-current sensor preferably has an electric coil through which there flows a controllable or constant operating current. The current flowing in the coil causes an electromagnetic field whose field lines penetrate the bandsaw blade. As a result of this—caused by the electromagnetic induction—a voltage is induced in the electrically conductive material of the bandsaw blade. Preferably, the magnetic field is oriented substantially perpendicularly (±10%) to the blade surface.

In this refinement, the eddy-current sensor is oriented relative to the bandsaw blade such that a notional line of action of the sensor, conceived between a north and south pole of the electromagnetic field, defines a normal to the surface of the bandsaw blade.

The induced voltage causes eddy currents in the electrically conductive bandsaw blade, which result in field weakening of the electromagnetic field (also known as Joule losses). The dimensional properties of the body penetrated by the electromagnetic field (in this case the bandsaw blade) can be inferred based on the strength of the eddy currents, or based on the weakening of the electromagnetic field.

In other words, the eddy-current sensor is based on the principle that a sensor head of the eddy-current sensor induces eddy currents in the moving bandsaw blade based on an alternating magnetic field. The Joule losses caused by the eddy currents are in this case proportional to the distance of the sensor head from the blade surface of the bandsaw blade. The eddy-current sensor outputs an (analogue) sensor signal proportional to this distance, in the form of a current signal and/or voltage signal.

In a further refinement, the evaluation unit is configured to determine an amplitude and/or phase of the eddy currents based on the sensor signal, and to generate the warning signal if the amplitude and/or phase of the eddy currents exceeds the predetermined tolerance range.

In this refinement, it is not only possible for the eddy-current sensor to infer a possibly impending blade breakage based on the dimensional properties of the bandsaw blade, but this prediction may also be made, alternatively or additionally, based on the eddy currents occurring in the bandsaw blade, for example through the evaluation of the Joule losses. If these Joule losses, or the strength of the eddy currents, exceed a predefined limit value ±of a still permissible deviation (for example of ±10%), the predetermined tolerance range is considered to have been exceeded, whereupon the evaluation unit generates the warning signal.

In a further refinement of the bandsaw, the eddy-current sensor further comprises a transmitter and a receiver, wherein the transmitter and the receiver are arranged on one and the same side of the bandsaw blade.

In the case of an eddy current sensor configured in such a manner, the transmitter and the receiver may be arranged, for example, concentrically with each other in a common housing, the transmitter being configured, for example, as a tubular coil, whereas the receiver is arranged in the hollow region of the coil.

The transmitter is configured to generate the electromagnetic field based on a controllable or constant operating current. The receiver, which is preferably pre-calibrated with respect to the transmitter, is configured to measure a strength of the electromagnetic field generated by the transmitter, minus possible losses (for example, caused by eddy currents). The receiver is thus preferably configured to receive the sensor signal, and transmits it to the evaluation unit.

In a further refinement of the bandsaw, the eddy-current sensor further comprises the transmitter and the receiver, wherein the transmitter and the receiver are arranged on mutually opposite sides of the bandsaw blade.

In this refinement, the bandsaw blade is thus preferably arranged between the transmitter and the receiver. The transmitter and the receiver are thus preferably not arranged in one and the same housing, but separately from each other. The receiver is preferably configured to wirelessly receive a magnetic field generated by the transmitter, minus the losses caused by the bandsaw blade.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an example of a device for predicting a blade breakage according to the present disclosure, and of an example of a bandsaw including the device;

FIG. 2 is a planar view of an example of a bandsaw blade included in the bandsaw of FIG. 1; and

FIG. 3 is a schematic view of an example of an eddy-current sensor according to the present disclosure.

Corresponding reference numerals indicate corresponding parts throughout the several views of the drawings.

### DETAILED DESCRIPTION

Example embodiments will now be described more fully with reference to the accompanying drawings.

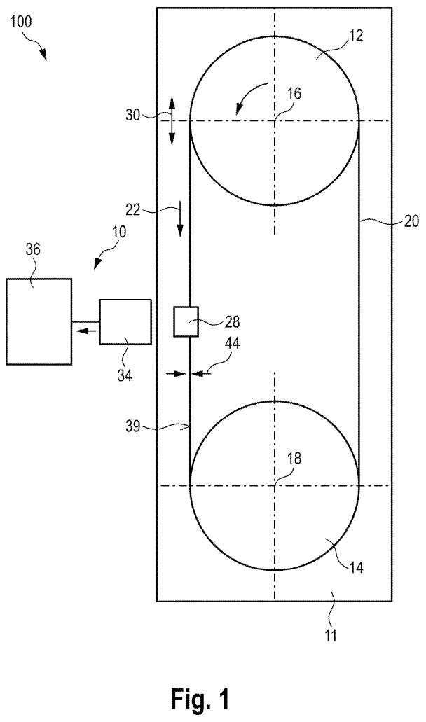

FIG. 1 schematically shows a bandsaw 100 comprising a device 10 for predicting a blade breakage. The bandsaw 100 has a bandsaw stand 11, arranged on which, preferably mounted in a rotatable manner, there is a first and a second bandsaw wheel 12, 14. The first and second bandsaw wheels 12, 14 rotate about two axes of rotation 16, 18 that are spaced apart from one another in the vertical direction, the axes of rotation 16, 18 extending orthogonally into the blade plane at the respective center of the cross in the view shown here.

The first and the second bandsaw wheel 12, 14 may be, for example, a roller or a drum. Preferably, at least one of the bandsaw wheels 12, 14 is motor-driven.

A motor drive of the bandsaw wheels 12, 14 may be realized, for example, by an internal combustion engine, a pneumatically or hydraulically operating motor or an electric motor. In further embodiments, a drive may also additionally have a gear unit by means of which the rotational speed between a motor output shaft and the respective bandsaw wheel 12, 14 to be driven can be varied.

A bandsaw blade 20 is guided over the two bandsaw wheels 12, 14 in such a manner that it is set in a revolving motion around the first and second bandsaw wheels 12, 14, along a sawing direction 22, when the first and second bandsaw wheels 12, 14 rotate about their respective axis of rotation 16, 18. In the shown embodiment, the rotational motion of the two bandsaw wheels 12, 14 is counter-clockwise.

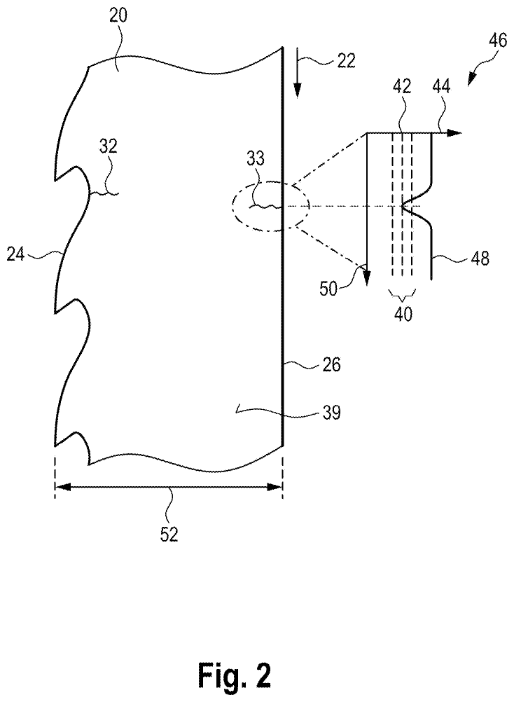

The bandsaw blade 18 has a toothed side 24 and a non-toothed side 26 (see FIG. 2). The toothed side 24 is often referred to as the tooth side and the non-toothed side 26 as the blade back. The toothed side 24 has a multiplicity of saw teeth configured to cut a material 28 to be sawed. The material 28 to be sawed is guided along a feed direction (not shown here) parallel to the axes of rotation 16, 18 onto the toothed side 24 of the bandsaw blade 20, and is sawed up by the multiplicity of saw teeth. The material 28 to be sawed may be, for example, a whole tree trunk, a board or any other object to be sawed. In other embodiments, the bandsaw blade 20 may also be toothed on both sides or toothless, e.g. diamond-coated for cutting stones.

In order to ensure safe and stable guiding of the bandsaw blade 20 on the bandsaw wheels 12, 14, the bandsaw blade 20 is (mechanically) tensioned between the first bandsaw wheel 12 and the second bandsaw wheel 14. For the purpose of tensioning the bandsaw blade 20, for example the first and/or second bandsaw wheel 12, 14 is/are moved away from each other along a tensioning path 30, which is illustrated in FIG. 1 by means of a double arrow.

During the machining process, the bandsaw blade 20 is subject to a constant, very high mechanical and thermal stress, which can cause blade cracks 32, 33 (see FIG. 2) in the bandsaw blade 20 in microscopic and macroscopic form. These blade cracks 32, 33 pose a risk to the sawing process, as they can result in a blade breakage, which can destroy parts of the bandsaw 100.

For early prediction of a blade breakage of the bandsaw blade 20, the bandsaw 100 comprises the device 10. The device 10 comprises an eddy-current sensor 34, which is configured to generate a sensor signal that is dependent on and indicates a technical parameter of the bandsaw blade 20. The sensor signal is transmitted via one or more cables or wirelessly to an evaluation unit 36.

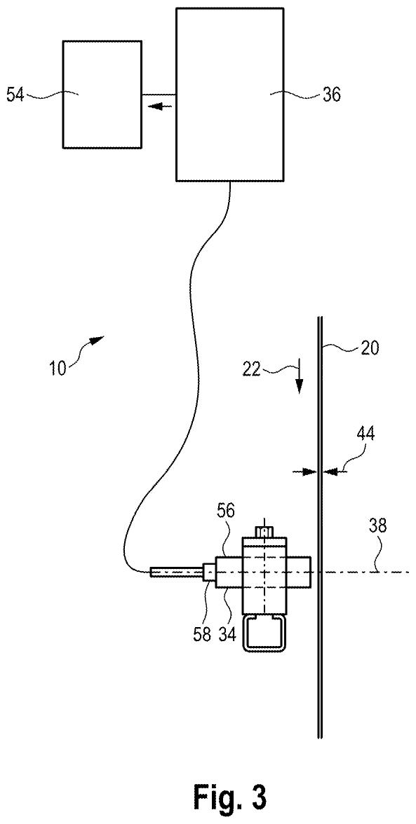

The eddy-current sensor 34 is preferably a commercially available eddy-current sensor. Preferably, the eddy-current sensor 34 is configured to sense the technical parameter of the bandsaw blade 20 while the bandsaw blade 20 revolves around the two bandsaw wheels 12, 14 at a sawing speed of, for example, 50 meters per second (m/s). The eddy-current sensor 34 is preferably oriented in such a manner that an effective direction 38 of the eddy-current sensor 34 is substantially perpendicular (for example ±5%) to at least one of the two axes of rotation 16, 18 and the sawing direction 22 (see FIG. 3). The effective direction 38 defines, as it were, a normal direction to a blade surface 39 of the bandsaw blade 20.

The evaluation unit 36 is configured to evaluate the sensor signal, to compare it with a predetermined tolerance range 40 (FIG. 2) and to generate a warning signal indicating an imminent blade breakage of the bandsaw blade 20 if the sensor signal lies outside of the predetermined tolerance range 40. The predetermined tolerance range 40 may be defined, for example, by a tolerable 10% deviation from a tolerance value 42. The warning signal may be generated as an audible sound signal or displayed as a visual message “Attention blade breakage” on a screen.

The technical parameter may be, for example, a dimensional property of the bandsaw blade 20, preferably a saw blade thickness 44. In this case, the tolerance value 42 describes a bandsaw-blade limit thickness. In this case, the tolerance range 40 is defined by a tolerable, e.g. 10%, deviation from the bandsaw-blade limit thickness.

Alternatively, the technical parameter may also be an amplitude and/or phase of the eddy current sensed by the eddy-current sensor 34. If the sensed eddy current exceeds a predetermined limit value (for example, taking into account a 10% deviation), the warning signal is output by the evaluation unit 36.

Represented in FIG. 2, in addition to the bandsaw blade 20, there is also an exemplary diagram 46, from which an exemplary (graphic) evaluation of the sensor signal is represented. In the diagram 46, for greater clarity, a curve 48 of the saw blade thickness 44 (abscissa) is plotted over a saw blade length 50 (ordinate) of the bandsaw blade 20 running parallel to the sawing direction 22. As a rule, however, crack detection is preferably effected by the evaluation of anomalies in the sensor signal, for example can be determined by evaluation of the amplitude and/or phase of the eddy current sensor signal.

It can be seen that the saw blade thickness 44 decreases in the course of the length at the point where the blade breakage 33 occurs, down to the tolerance value 42, i.e. the saw-blade limit thickness, but is still within the tolerance range 40. Thus, preferably no warning signal is output at this point, but the evaluation unit already recognizes that this point in the course of the length of the bandsaw blade 20 marks a critical point for blade breakage.

Preferably, the eddy-current sensor monitors the blade thickness 44 of the bandsaw blade 20 over an entire width 52 of the bandsaw blade.

In FIG. 3, the device 10 has a control unit 54 in addition to the evaluation unit 36. The evaluation unit 36 is configured to transmit the warning signal to the control unit 54 via one or more cables or wirelessly. The control unit 54 is configured to switch off the bandsaw 100 when it receives the warning signal.

Preferably, it is possible for the evaluation unit 36 to generate different warning signals, each indicating different stages of an incipient blade crack 32, 33 of the bandsaw blade 18. It is advantageous if, for example, a first warning signal is generated by the evaluation unit 36 when first signs of an incipient blade crack 32, 33 are detected (as is the case, for example, in FIG. 2 in diagram 46), and a second warning signal is generated when a blade crack 32, 33 is already in an advanced stage (in the case of diagram 46, for example, falls below the tolerance value 42 (e.g., by more than 10%). In this case, for safety reasons, the bandsaw 100 may be switched off by the control unit 54 or manually by an operator. Such a cascaded warning signal makes it possible, for example, to inform an operator about a stage of an impending blade breakage. If the blade crack 32, 33, for example, reaches an order of magnitude of ⅓ of the blade width 52 of the bandsaw blade 20, the bandsaw 100 is switched off immediately.

Further, the eddy-current sensor 34 has a transmitter 56 and a receiver 58. The transmitter 56 is configured to generate a magnetic field oriented perpendicularly to the blade surface 39 of the bandsaw blade 20, the field lines of which penetrate the blade surface 39 of the bandsaw blade 20 in an effective direction between the two field poles, and penetrate it completely in the thickness direction of the bandsaw blade 20. The transmitter 56 and the receiver 58 are located on one and the same side of the bandsaw blade 20.

The receiver 58 is preferably configured to detect a strength of the magnetic field generated by the transmitter 56, minus the Joule eddy-current losses generated when penetrating the bandsaw blade 20, or merely the eddy currents generated in the bandsaw blade by induction, in the form of the sensor signal.

It is to be noted that the features shown in the above embodiments may be used in other embodiments in a modified form, as well as alternatively or complementarily to each other, or even that individual features do not have to be present.

Thus, for example, the arrangement of the individual features may vary, without departing from the spirit and scope of the present disclosure. In other embodiments, for example, one of the axes of rotation 16, 18 may be configured such that it can be inclined relative to the other axis of rotation 16, 18, such that the two axes of rotation 16, 18 in these embodiments are not parallel to each other. Moreover, in other embodiments, both bandsaw wheels 12, 14 may also be motor-driven. Likewise, it is not absolutely necessary to orient the two bandsaw wheels 12, 14 vertically with respect to each other. Moreover, it should be mentioned that the device 10 can be used with any type of bandsaw, which may also have, for example, a bandsaw blade that is toothed on both sides, in order thus to be able to saw workpieces both along and contrary to the feed direction.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A device for predicting a blade breakage of a bandsaw blade of a bandsaw, the device comprising:
an eddy-current sensor configured to generate a sensor signal that is dependent on a technical parameter of the bandsaw blade; and
an evaluation unit configured to evaluate the sensor signal, to compare the sensor signal with a predetermined tolerance range, and to generate a warning signal that indicates an imminent blade breakage of the bandsaw blade if the sensor signal lies outside of the predetermined tolerance range.

2. The device as claimed in claim 1, wherein the evaluation unit is configured to determine the technical parameter based on the sensor signal.

3. The device as claimed in claim 1, wherein the evaluation unit is configured to electronically filter the sensor signal before comparing the sensor signal with the predetermined tolerance range.

4. The device as claimed in claim 1, wherein the evaluation unit is configured to electronically smooth the sensor signal before comparing the sensor signal with the predetermined tolerance range.

5. The device as claimed in claim 1, wherein the technical parameter comprises a dimensional property of the bandsaw blade.

6. The device as claimed in claim 1, wherein the evaluation unit is configured to determine from the sensor signal, as the technical parameter, a saw blade thickness of the bandsaw blade, and to generate the warning signal if the saw blade thickness is outside of the predetermined tolerance range.

7. The device as claimed in claim 1, wherein the eddy-current sensor is configured to generate the sensor signal while the bandsaw blade is executing a revolving motion.

8. The device as claimed in claim 1, wherein the eddy-current sensor is configured to generate a magnetic field oriented perpendicularly to a blade surface of the bandsaw blade, the magnetic field inducing in the bandsaw blade a voltage that causes eddy currents.

9. The device as claimed in claim 8, wherein the evaluation unit is configured to determine an amplitude of the eddy currents based on the sensor signal, and to generate the warning signal if the amplitude of the eddy currents exceeds the predetermined tolerance range.

10. The device as claimed in claim 8, wherein the evaluation unit is configured to determine a phase of the eddy currents based on the sensor signal, and to generate the warning signal if the phase of the eddy currents exceeds the predetermined tolerance range.

11. A bandsaw, comprising:
a first bandsaw wheel rotatably mounted about a first rotation axis;
a second bandsaw wheel rotatably mounted about a second rotation axis, the second rotation axis being arranged parallel to and spaced apart from the first rotation axis;
a bandsaw blade that is guided over the first bandsaw wheel and the second bandsaw wheel so as to execute a revolving motion around the first bandsaw wheel and the second bandsaw wheel; and
a device for predicting a blade breakage of the bandsaw blade, the device comprising:
an eddy-current sensor configured to generate a sensor signal that is dependent on a technical parameter of the bandsaw blade; and
an evaluation unit configured to evaluate the sensor signal, to compare the sensor signal with a predetermined tolerance range, and to generate a warning signal that indicates an imminent blade breakage of the bandsaw blade if the sensor signal lies outside of the predetermined tolerance range.

12. The bandsaw as claimed in claim 11, wherein the eddy-current sensor comprises a transmitter and a receiver, the transmitter and the receiver being arranged on a same side of the bandsaw blade.

13. The bandsaw as claimed in claim 11, wherein the eddy-current sensor comprises a transmitter and a receiver, the transmitter and the receiver being arranged on mutually opposite sides of the bandsaw blade.

14. The bandsaw as claimed in claim 11, wherein the evaluation unit is configured to determine the technical parameter based on the sensor signal.

15. The bandsaw as claimed in claim 11, wherein the evaluation unit is configured to electronically filter the sensor signal before comparing the sensor signal with the predetermined tolerance range.

16. The bandsaw as claimed in claim 11, wherein the evaluation unit is configured to electronically smooth the sensor signal before comparing the sensor signal with the predetermined tolerance range.

17. The bandsaw as claimed in claim 11, wherein the technical parameter comprises a dimensional property of the bandsaw blade.

18. The bandsaw as claimed in claim 11, wherein the evaluation unit is configured to determine from the sensor signal, as the technical parameter, a saw blade thickness of the bandsaw blade, and to generate the warning signal if the saw blade thickness is outside of the predetermined tolerance range.

19. The bandsaw as claimed in claim 11, wherein the eddy-current sensor is configured to generate the sensor signal while the bandsaw blade is executing a revolving motion.

20. The bandsaw as claimed in claim 11, wherein the eddy-current sensor is configured to generate a magnetic field oriented perpendicularly to a blade surface of the bandsaw blade, the magnetic field inducing in the bandsaw blade a voltage that causes eddy currents.
